(19) United States
(12) Patent Application Publication
(10) Pub. No.: US 2011/0204552 A1
(43) Pub. Date: Aug. 25, 2011

(54) CLAMPING DEVICE AND BASE MODULE THEREFOR

(75) Inventors: Hanspeter Sautter, Otelfingen (CH); Jürgen Banholzer, Winterthur (CH)

(73) Assignee: SWISSCETEC GMBH, Winterthur (CH)

(21) Appl. No.: 12/673,305

(22) PCT Filed: Aug. 13, 2008
(86) PCT No.: PCT/CH08/00345

§ 371 Date: Oct. 13, 2010

(30) Foreign Application Priority Data
Aug. 15, 2007 (CH) 1288/07

(51) Int. Cl. B25B 11/00

(52) U.S. Cl. 269/20

(57) ABSTRACT

A universal tensioning apparatus for a work piece to be tensioned, having a housing with a pressure chamber filled with a pressure medium and a covering sealing the housing and the pressure chamber. In the area of the housing a pressure introduction element is located for exerting pressure on the pressure medium and a pressure transferring element for transferring the pressure of the pressure medium onto a tensioning element to be tensioned. The pressure medium is an elastic solid and the pressure is adjustable and controllable by a pressure sensor. The pressure medium is preferably a one-piece silicon substance by which a pressure introduced radially relative to the longitudinal axis of the apparatus is transferred by the pressure-transferring element axially onto the tensioning element.

### BACKGROUND OF THE INVENTION

1. Field of the Invention

The invention lies in the field of clamping devices for work-pieces, and in particular relates to a clamping device and a base module therefor, with a pressure chamber filled with a hydraulic medium, according to the independent patent claims.

2. Description of Related Art

Hydraulic clamping devices are known from patent literature, with which a pressure transmission to clamping jaws for clamping a tool is effected via a hydraulic medium. Such a clamping device for inner and outer clamping is described in DE 200 2006 015 097. Thereby, pressure sensors are assigned to the hydraulic clamping cylinder, in order to recognise a clamped or loose condition of the clamping jaws by way of a pressure which is reached in the respective pressure chambers. The described device, as all hydraulic clamping devices, has the disadvantage that the fluid circuit must be sealed as precisely as possible with the use of a hydraulic medium. Reliably functioning sealing, as known, is expensive, extensive and/or prone to defect, in particular with high operating pressures. A leaking hydraulic medium is not only to be avoided due to undesired contamination, but even a slightly variable filled quantity has a large effect on the pressure in the hydraulic system. If a tool or work-piece is clamped too strongly, deformations or even breakage may occur. A work-piece which is clamped too weakly may change its position during machining or even detach completely. Both are undesirable or dangerous conditions, and are to be avoided.

In the device known from DE 20 2006 015 097, the clamping pressure is predefined. Via the pressure measurement, it is specified as to whether the clamping jaws are in a clamped condition or a loose condition. The device is, thus, not suitable for the use for different work-pieces which require a different clamping pressure. Moreover, the “two-condition display” via the hydraulic conduits is not suitable for exact information with regard to the clamping pressure prevailing at the work-piece.

A rotation clamping device for tools is described in WO 2005/044491. In this, the fluid hydraulic medium is replaced by elastic solid matter rings which are arranged in a narrow pressure chamber. An extension sleeve clamping a tool, the solid matter rings as well as a clamping ring are arranged next to one another in a precisely dimensioned and centric manner. The pressure chamber is reduced in size by way of screwing in the clamping ring, and the solid matter rings transmit the pressure onto the extension sleeve. A sliding ring is provided on an end-face, in order to decouple the solid matter rings from the rotational movement. Moreover, a fluid lubricant must be provided between the solid matter rings and the clamping ring, in order to prevent friction and torsion forces. The clamped condition is given by an abutment of the clamping ring in this device too. An adaptation of a clamping pressure, for example with a certain wear of the solid matter bodies, is not possible. This device is suitable exclusively for rotationally symmetrical and tolerance-compliant tools.

### BRIEF SUMMARY OF THE INVENTION

It is therefore the object of the invention to provide a clamping device and a base module for such a clamping device, which overcomes disadvantages according to the state of the art, and which, in particular, has a compact construction and permits a universal work-piece clamping with a variable and controllable pressure impingement.

This object is achieved by the clamping device and the base module as defined in the patent claims.

The clamping device for a tool to be clamped comprises a base module and a clamping element to be clamped, which is firmly but preferably releasably connected to the base module. Thereby, the actual pressure build-up or force build-up which is required for clamping the work-piece is effected in the base module, and the actual clamping of the work-piece or generally the force transmission directly onto a work-piece, is effected in the clamping element.

The base module comprises a housing with a pressure chamber filled with a pressure medium, and a cover terminating the housing and the pressure chamber. A pressure introduction element for impinging the pressure medium with pressure as well as a pressure transmission element for transmitting the pressure medium onto a clamping element to be clamped, is located in the region of the housing. There, the pressure medium is an elastic solid body and the pressure is measurable via a pressure sensor.

The pressure sensor, thereby, is preferably likewise introduced in the housing and is in direct contact with the pressure medium. It permits a constant observation and by way of this, a setting, variation and control of the pressure, wherein a pressure display may be effected in an electronic or mechanical manner, outside or also on the device.

It is the merit of this invention, amongst other things, that it has recognised that there is a need to provide a clamping device in which a clamping pressure may be controlled, and when required may also be set and varied. This not only permits a varied application possibility of the clamping device for the most varied of work-piece shapes and materials, with this, it is also possible to achieve exactly reproducible clamping pressures. In particular, the provision of a base module which may be combined with varied clamping elements, renders the present invention universally applicable.

Until now, a clamping device permitted only a certain clamping pressure or it was left to the experience of the specialist to set an as suitable as possible clamping pressure for a certain work-piece. Thanks to the possibility of a precise pressure monitoring, for the first time a precise setting of an optimal clamping pressure is possible with the invention. For example, one may see when the elasticity limit or the yield point of a work-piece is achieved by way of the pressure display.

By way of the use of an elastic solid body as a pressure medium, the clamping device uses the advantages of hydraulic pressure transmissions, but without their disadvantages which the use of hydraulic fluid entails. The pressure medium is treated well due to the construction of the base module which preferably makes do without any torsional movements of the pressure medium. This not only has a positive effect on the life duration, but also on the precision and reproducibility of the device.

In a preferred embodiment, a pressure transmission element is arranged in a movable manner along a longitudinal axis of the base module, wherein the actual pressure introduction however is carried out laterally on the housing and is also transmitted radially into the pressure chamber. This is preferably effected by way of a pressure transmission screw introduced in the housing, which is connected to a pressure distributor piston arranged in the pressure chamber. This distributes the introduced pressure onto an as large as possible area of the pressure medium.

A lateral force introduction permits a simple deposition of the base module or the clamping device onto a work-bench or machine. In known clamping devices, a pressure impingement, as a rule, is effected in the axial direction to the clamping device and to the likewise axially clamped work-piece, thus either from the work-piece side or from the rear side of the clamping device. If the clamping device is provided for attachment onto a machine, a connection or access from the rear side is either awkward or permits no clamping in the assembled condition of the clamping device. The base module according to the invention and the clamping device according to the invention, thus, preferably have no connections or accesses in the base region at all, which need to be accessible during a clamping process. With this, as the case may be, it is also possible to already assemble a base module and to retrospectively attach a clamping element on the base module or to exchange such a clamping element.

In a preferred embodiment, a clamping element for inner clamping and outer clamping comprises several, e.g. 6-10 segments which are connected to one another. These segments arise by way of radially continuous notches in an upper region of the clamping element. A lower base region of the clamping element is coherent and may have a variable thickness. A lower thickness reduces a required clamping force, and a larger thickness provides sufficient strength, e.g. for engaging a clamping screw.

A very simple conversion of the clamping device from an inner clamping to an outer clamping is possible with the described construction. With the outer clamping, a base module is provided with a clamping element, with which a work-piece to be clamped is applied between the segments. This work-piece does not necessarily need to be rotationally symmetrical. The segments, when required, may have recesses in the form of a work-piece to be clamped. For inner clamping, the base module is provided with a slightly varied clamping element, with which a conically shaped peg may be arranged between the segments. This is then axially displaced over the clamping screw and thus presses the segments apart, so that an inner clamping of a work-piece pushed over the clamping element or also a holding device, may be realised. A different shape of the work-piece to be clamped thus merely requires an adaptation of the clamping element. No changes in the clamping production region are necessary at all due to the clamping pressure which may be set.

The use of the device is neither restricted to rotationally symmetrical work-pieces nor to tolerance-compliant tools.

The construction of the base module, but also of the clamping device, in which all components required for a clamping are accommodated, is very compact and also permits the use in very restricted conditions. The base module and the clamping device are constructed in an as simple as possible manner and may preferably be disassembled into their individual components by way of simply taking apart. The base module may thus be adapted to different areas of application, i.e. an inner clamping or outer clamping, to tools shapes and materials which are to be machined differently, to an attachment on a machine tool, etc., with little expense with regard to time and material. For this, preferably all elements and components which are located in the housing and are adjacent to one another, are in contact with one another. These however are preferably not connected to one another unless their function renders it necessary, for example the connection of a clamping screw to a clamping element. This also simplifies a simple taking apart and putting together of the device, for example for cleaning or exchanging individual components.

An as symmetrical as possible arrangement, which is preferably also balanced, is advantageous for the application of the base module/clamping device for rotation processes such as turning or grinding. If the clamping device for clamping however is not applied in the rotational condition, one may do without any balancing and, for example, the arrangement of the individual elements of the device, in particular of the base module. For example the pressure sensor and pressure transmission element may be arranged in an essentially infinite manner in the housing, as the case may be, also in a covering. The individual elements, for example a pressure transmission piston, may be further optimised with regard to their actual function, also with regard to shape and dimensions.

The base module with the housing with pressure chamber, pressure medium and covering forms a system which is independent per se and is only connected via a clamping screw to the clamping element attached onto the housing. With this, the actual clamping production region is essentially independent of which shape a tool to be clamped has, of whether this is a material piece to be machined or a tool to be clamped or of whether an inner clamping or outer clamping is necessary. This separation of the clamping region and the actual clamping production region renders the clamping device, and in particular the base module, simple and favourably applicable for different fields.

The clamping elements may be collets for inner clamping and outer clamping, but also clamping jaws, clamping elements with two, three or four jaw chucks, such as centering clamps or also general systems for linear force transmission, etc.

The clamping device, in particular the base module, may thus be applied in a comprehensive manner. With the use of an elastic solid body as a pressure medium, the clamping device utilises the advantages of hydraulic pressure transmissions, without however their disadvantages, which the use of hydraulic fluid entails. This is favorable with regard to production costs and offers advantages with the maintenance of the device.

The elastic solid body is moreover preferably made of a material as temperature-resistant as possible, which is not capable of flowing, even under the impinged pressure, for example a plastic mass as is applied for sealing windows. In order to further reduce the temperature-dependence of the pressure medium, another material may be introduced into the elastic mass which has even better parameters e.g. with regard to the temperature. This may be a non-elastic solid body, but also a fluid which is completely enclosed by the elastic mass.

### BRIEF DESCRIPTION OF THE DRAWINGS

The invention is hereinafter described by way of exemplary drawings. Thereby there are shown in:

FIG. 1 a schematic view of a clamping device,

FIG. 2 a sectioned view along A-A of FIG. 1,

FIG. 3 a plan view of the opened clamping device,

FIG. 4 a view of the clamping device according to FIG. 1,

FIG. 5 a base module,

FIG. 6 a view on the opened base module,

FIG. 7 a variant of the collet for inner clamping,

FIG. 8 one embodiment form of a pressure medium,

FIG. 9a, bone variant of a non-rotationally symmetrical inner clamping,

FIG. 10 one variant of a two-jaw centering clamp,

FIG. 11 one variant of a three-jaw centering clamp.

### DETAILED DESCRIPTION OF THE INVENTION

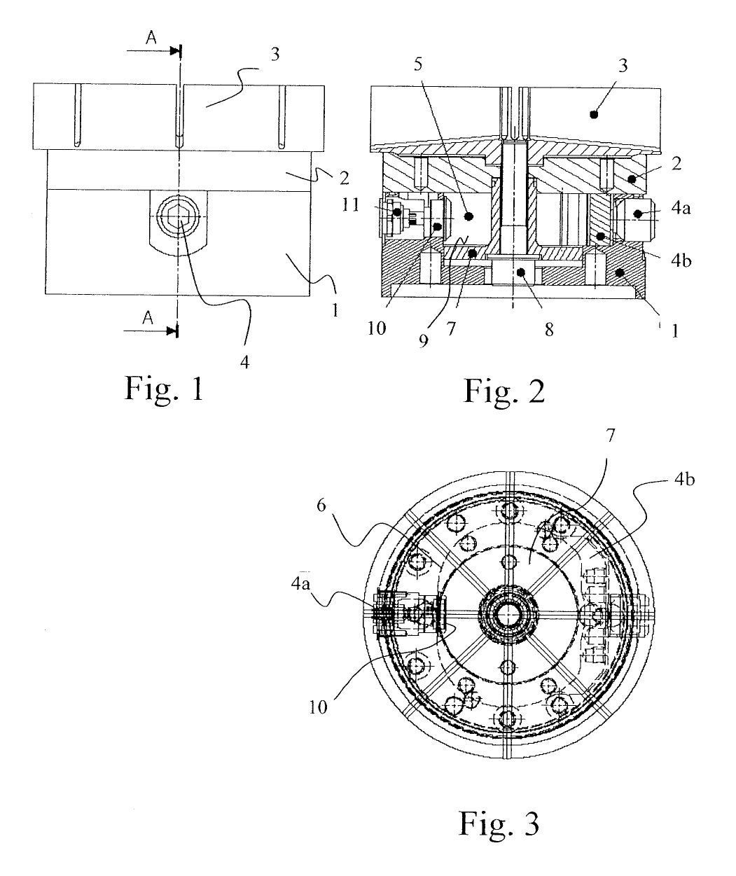

FIGS. 1 and 2 show an outer view and a sectioned view (along the section lines A-A) of a clamping device with a clamping element designed as a collet 3, for the outer clamping of a work piece. The clamping device comprises a housing 1 having a pressure chamber 5, a cover 2 which terminates the housing to the top or on the work-piece side, and a collet 3 deposited on the cover. The essentially cylinder-shaped housing comprises a pressure introduction element 4 which is arranged in the housing laterally with respect to the longitudinal axis of the cylinder. This pressure transmission element consists of a pressure introduction screw 4a, e.g. a hexagonal socket screw and an introduction pressure distributor piston 4b. The screw 4a is actuated laterally from outside the housing, in an electronic or mechanical manner, and permits an impingement of the clamping device with a required pressure. The pressure transmission screw 4a is in contact with the radially movable introduction pressure distributor piston 4b, as the case may be, via a decoupling element with which a rotation movement and translation movement are separated. The distributor piston in turn is in direct contact with a pressure medium 6 which fills out the pressure chamber, which is drawn in dashed lines in FIG. 3. FIG. 3 shows a plan view into a clamping device with elements drawn in a transparent manner.

The distributor piston 4b extends over the complete height and largely over the width of the pressure chamber. Pressure is exerted onto the pressure medium via the distributor piston 4b by way of tightening or rotating in the introduction screw 4. The distributor piston is designed such that it may distribute the pressure of the introduction screw onto an as large as possible region of the pressure medium. On account of the elasticity of the pressure medium, the pressure is transmitted to all sides onto a pressure transmission piston 7 which is arranged centrally in the housing and is axially movable therein. This is in direct contact with at least the head end of a clamping screw 8, which in turn, preferably via a thread, is connected to the collet 3. The pressure transmission piston 7 has a cylinder-shaped hollow shank for receiving the clamping screw. Moreover, it comprises a widened, flatly designed lower region with a press surface 9. The pressure medium is also in direct contact with this press surface 9, so that the pressure exerted onto the pressure medium acts directly on this pressure surface 9. The piston 7, by way of this, moves downwards in order to escape the pressure, and by way of this thereby presses the clamping screw likewise downwards. The collet 3 attached at the opposite end of the clamping screw is pulled downwards in its central region by way of this. The collet deforms by way of this, and the individual segments 3a of the collet move slightly downwards and towards one another and clamp a work-piece introduced between the segments.

The elasticity of the pressure medium permits a deformation and also after pressure impingement ensures a reliable contact with the walls of the pressure chamber or with the component located in the pressure chamber. The same also applies to a pressure relief. The intrinsic tension of the collet attempts to assume the released, i.e. unloaded condition. The pressure medium is accordingly relieved and assumes its original shape. In particular, a constant contact to the pressure sensor 10 is given by way of an exact fitting of the pressure medium into a pressure chamber, said pressure sensor being introduced on the opposite side of the pressure transmission for rotationally symmetrical reasons. This pressure sensor, via a plug 10 introduced on the housing at the outside, may be connected to an external electronic pressure display and be read off (not drawn in), and this may however also be attached directly on the housing such that it may be read off. Accordingly, the pressure information which is important for the clamping may be controlled and set at each point in time. Changes of a work-piece to be clamped, for example on achieving an elasticity limit or yield limit, may also be recognised with this.

An interface for a contactless transmission of the sensor information, e.g. via radio, Bluetooth, etc. may be present instead of a plug.

The axial movement of the pressure transmission piston, and thus also of the clamping screw, as a rule lies in a very small range of 0.1-2 mm, preferably between 0.2 mm and 0.8 mm, e.g. 0.4 mm. The extension of the axial movement, depending on the size of the clamping device, may also vary in a larger range. However, it is possible with the very small piston movements in the present invention, of for example a fraction of a millimeter, to design a very compact base module and thus also a very compact clamping device. In particular, the piston may be integrated into the closed housing, which is kept very small. Exemplary values and masses for one embodiment are achievable tensile forces of up to 20 kN which may be achieved in a clamping device with housing dimensions of approx. 100 mm diameter and 75 mm height.

The collet comprises several clamping segments 3′ which are coherent in its base region. The base region of the collet is not uniformly thick between the segments, but slightly thinned out towards the edge regions. A certain thickness in the region of the clamping screw ensures strength and retention. The required force for a deformation of the collet is reduced by way of the thinning towards the edge region.

In the figures, one may easily see the individual elements and their geometric matching to one another. For example, the pressure distributor piston extends over the complete height of the pressure chamber and up to, but not in the region of the pressure transmission piston 7. This with its widened end lies in a recessed region in the base of the pressure chamber. This recess however is filled by the piston, in a manner such that the pressure surface 9 of the piston lies flush to the remaining base of the pressure chamber without pressure impingement. Thus, no empty spaces, above all also no temporary ones, arise in the pressure chamber, which may not be reached by the elastic pressure medium. Essentially, the desired pressure impingement and movement path is set with the selection of the ratio of the surface area of the pressure distributor piston to the pressure surface area of the pressure transmission piston.

In order to design a pressure introduction in a sensitive manner, to design it with little rotation or little or low force effort of the pressure introduction screw 4a, the pitch of the thread of the screw is selected accordingly. In this embodiment, a decoupling element, preferably a ball (not to be seen in the figure) is introduced into the inner lying end of the screw 4a, so that no torsional forces are transmitted from the pressure introduction screw 4a onto the pressure distributor piston 4b. This element or the ball is typically held in the screw, but is freely rotatable about the screw longitudinal axis. In the case of a ball, the region which is directly connected to the pressure distributor piston is flattened, in order to increase the contact surface between the ball and the piston. The rotation movement and translation movement of the screw is separated by way of the decoupling element, and it is only the lateral axial movement of the introduction screw 4a which is transmitted onto the distributor piston 4b, but no rotation movement.

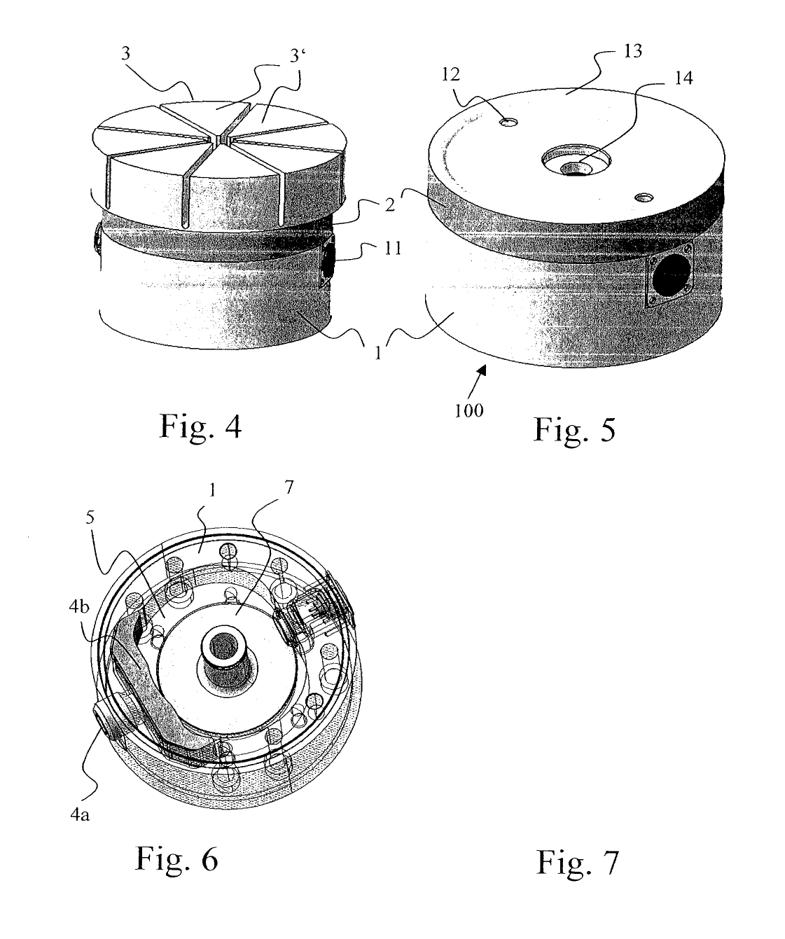

FIG. 4 shows an oblique view of the clamping device with the housing 1, cover 2, rotationally symmetrical collet with eight clamping segments 3′, as well as pressure introduction element 4 and plug connection 11 of the pressure sensor.

A work-piece to be clamped is applied between the segments 3′ of the collet. If the shape of the work-piece to be clamped is not symmetrical, and is neither round nor square, then the shape of the work-piece may be recessed, for example milled away, in the collet. Thus, essentially any shapes of work-pieces may in particular also be eccentrically clamped. An example of this, for an inner clamping, is shown in FIGS. 9a and 9b.

FIG. 5 shows an oblique view of a base module 100, here a clamping device with a removed collet which illustrates the very compact construction. One may see a central opening 14 in a recess in the cover for introducing a clamping screw. Moreover, the cover comprises a rotation protection 12 and further positioning means, here in the form of two bores, which lie opposite one another, into which corresponding projections of a collet or of another clamping element may be inserted. A position of a clamping element and, thus, also of a work-piece with regard to rotation may be determined and fixed by way of this. The cover moreover has a slightly raised, outwardly rounded edge 13. This encourages a uniform, central deformation of the collet segments and provides sufficient space for an axial movement of the segments.

The base module 100 as an actual clamping-producing region of the device is very compact and by way of attaching a suitable clamping element may be used in different clamping situations or for the most varied of work-pieces to be clamped.

An oblique view into a base module 100 with a removed cover is shown in FIG. 6. One may easily see the introduction pressure distributor piston 4b. In its middle, it comprises a slight recess at the height of the shank of the pressure transmission piston 7. The distributor piston 4b has a double guide in the housing (parallel vertical side surfaces) and in the cover, in order to prevent a jamming of the distributor piston.

A groove for an O-ring may be provided between the housing and the covering. This sealing serves for protecting the pressure chamber to the outside from contamination and fluids.

FIG. 7, in a very schematic manner, shows a detail of a clamping device in the region of a collet 9′, as may be used with an otherwise non-changed base module for an inner clamping. In contrast to an outer clamping, an additional conically shaped peg 19 may be introduced in a centric manner into the collet, which for this comprises a centrally milled-out region. This peg is in connection with the clamping screw 8, preferably via a thread. If a pressure is introduced into a pressure chamber, then the clamping screw is pulled downwards and with it the conical peg. The further this is pressed down, the greater the jaws of the collet are pressed to the outside and an inner clamping in the region of the periphery of the collet is effected.

The peg may also be designed such that the peg and with this also the clamping screw is fixed from above, or that also a pressure introduction is effected axially, via the peg. For this, the peg comprises suitable screw means 20. Either the complete peg is rotated in with the screw means or however the peg is provided with a lead-through, which effects a tightening of the peg without a rotation of this in the collet.

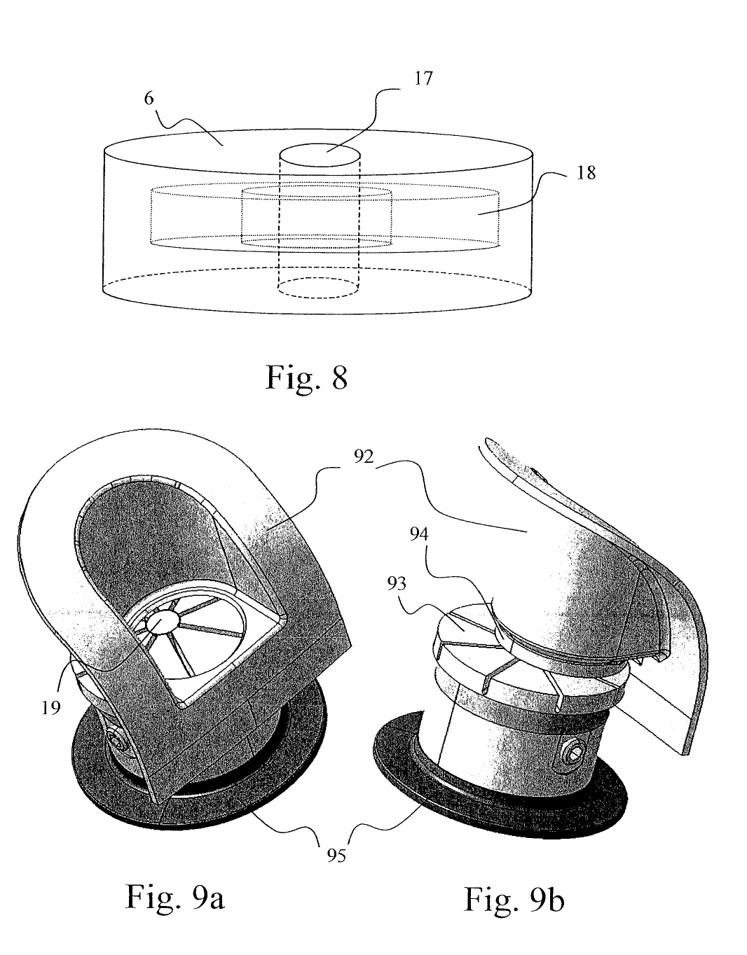

A pressure medium 6 as may be used in the basis module 100 or the clamping device according to the preceding figures, is shown schematically in FIG. 8. The pressure medium is a piece of a suitable elastic, solid-matter material for example silicone or of a different plastic. The pressure medium preferably has exactly the dimensions of the pressure chamber, so that this is completely filled, and a uniform pressure transmission on all sides of the medium is effected. The material of the pressure medium has such a viscosity that it does not flow through slots of the pressure chamber, even given a pressure impingement. In the inner region, the pressure medium has a cylinder shaped recess 17, which in the assembled condition bears on the shank of the pressure transmission piston 7 in a tight manner. Dimensions of the silicone body, for a housing shown in the FIGS. 1-6, lie at approx. 70 mm diameter and 20 mm height. A suitable hardness value for the silicone mass lies at about 35 Shore A.

The pressure medium preferably has an as small as possible temperature-dependence, so that a set clamping pressure remains constant given changing temperatures of the surroundings or changing operating temperatures. Additionally, a largely temperature-independent solid body 18 may be brought in the pressure medium, in order to reduce the temperature dependence. This is completely surrounded by the pressure medium and may thus also be non-elastic or even fluid. Such a solid body 18 is drawn in the figure in a dotted manner. It floats with the silicone mass and is for example of glass, ceramic or carbon.

FIGS. 9a and 9b show a non-rotationally-symmetrical work-piece 92, here specifically an inlet union for a helium tank, said work-piece being clamped into a suitably shaped collet for an inner clamping with a central peg 19, for further machining for example, for milling or welding. The work-piece 92 with the exception of a lower edge 94, has no cylindrical region which could be clamped into a conventional clamping device. Moreover, the work-piece comprises a downwardly projecting, laterally distanced straight edge which renders a clamping of the work-piece practically impossible. The collet 93 of the device, according to the invention now, corresponding to the lower edge 94 of the work-piece, comprises a recess into which the edge may be inserted and clamped therein. The recess is not introduced centrically in the collet 93, but laterally offset in a manner such that the projecting edge runs laterally outside the clamping device.

The base module 100 is attached on a holder 95, e.g. screwed on, via which the clamping device may be attached, for example to a work-bench or machine.

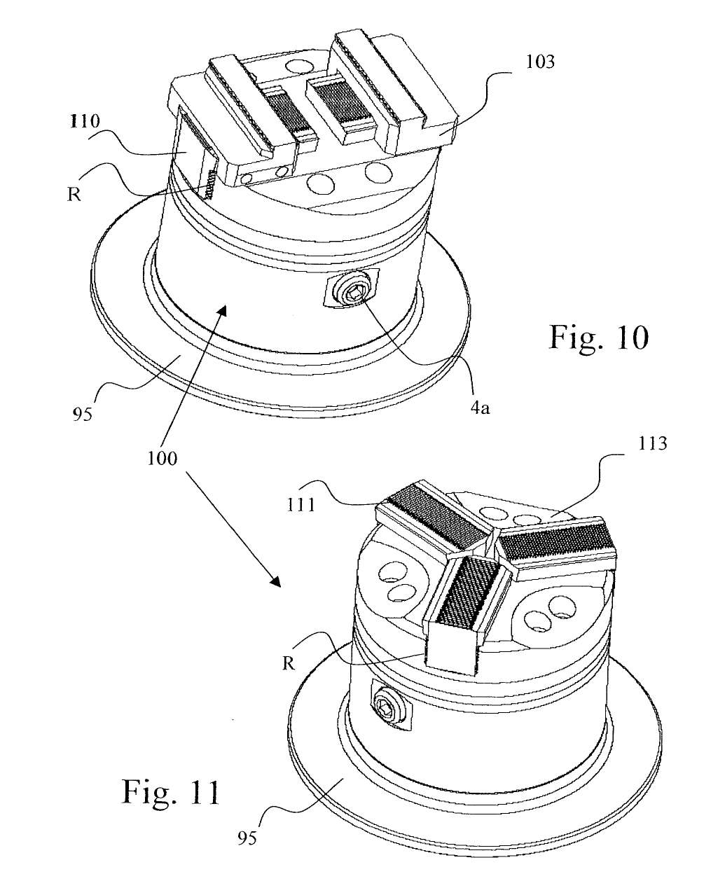

In each case a two-jaw and three-jaw centering clamp is shown in FIGS. 10 and 11. In this a base module 100, as has been described for example in FIGS. 5 and 6, is combined with suitable clamping elements. The same elements have been provided with the same reference numerals.

A two-jaw or three-jaw chuck 103, 113 is applied onto the base module. Thereby, two or three horizontally movable sliders 110, 111 are pressed to the inside or to the outside depending on the pressure impingement of the clamping device. The force application onto the slide may in principle be carried out similarly as described in FIG. 7. A conical peg corresponds with inner beveled surfaces of the slide (not shown) and presses the slide accordingly inwards or outwards, in order to effect a clamping. The slides 103, 113 are thereby guided in lateral slots R. This has the advantage that the plurality of slots may be manufactured with a conventional threaded tool. Compared to an individual groove which is normally common in such devices, they also have the advantage that no or only a significant weakening of the slides, clamping jaws or clamping element generally is effected by way of the smaller slots.

1-14. (canceled)

15. A base module for a clamping device for a work-piece to be clamped, comprising
a housing with a pressure chamber which is filled with a pressure medium,
a cover closing the housing and the pressure chamber,
a pressure introduction element for impinging the pressure medium with pressure located in the region of the housing,
a pressure transmission element for transmitting the pressure of the pressure medium onto a clamping element to be clamped,
wherein the pressure medium is an elastic solid body and the pressure is measured via a pressure sensor.

16. The base module according to claim 15, wherein the pressure transmission element is movably arranged along a longitudinal axis of the base module and wherein a pressure may be introduced laterally to the base module via the pressure introduction element.

17. The base module according to claim 15, wherein the pressure medium is a single-piece silicone mass.

18. The base module according to claim 17, wherein a non-elastic solid body, preferably a glass body or ceramic body, is completely enclosed by the pressure medium.

19. The base module according to claim 15, wherein the pressure introduction element is designed as a pressure introduction screw and as a pressure distributor piston, which pressure distributor piston is connected to the pressure introduction screw and is arranged in the pressure chamber.

20. The base module according to claim 19, wherein the pressure introduction screw is separated from the pressure distributor piston with regard to a rotation movement.

21. The base module according to claim 19, wherein the pressure sensor in the housing is arranged opposite the pressure introduction screw.

22. A base module for a clamping device for a work-piece to be clamped, comprising:
a housing with a pressure chamber which is filled with a pressure medium,
a cover closing the housing and the pressure chamber,
a pressure introduction element for impinging the pressure medium with pressure located in the region of the housing,
a pressure transmission element for transmitting the pressure of the pressure medium onto a clamping element to be clamped,
wherein the pressure medium is an elastic solid body and the pressure is measured via a pressure sensor, which sensor is arranged opposite a pressure introduction screw, which pressure introduction screw together with a pressure distributor piston form the pressure introduction element, which piston is arranged in the pressure chamber and is connected to the pressure introduction screw,
and wherein the pressure transmission element is movably arranged along a longitudinal axis of the base module and a pressure may be introduced laterally to the base module via the pressure introduction element.

23. A base module for a clamping device for a work-piece to be clamped, comprising
a housing with a pressure chamber which is filled with a pressure medium,
a cover closing the housing and the pressure chamber,
a pressure introduction element for impinging the pressure medium with pressure located in the region of the housing,
a pressure transmission element for transmitting the pressure of the pressure medium onto a clamping element to be clamped,
wherein the pressure medium is an elastic solid body, with a non-elastic solid body, preferably a glass body or ceramic body, completely enclosed by the elastic body.

24. A clamping device with the base module according to claim 15 with a clamping element for the inner clamping or outer clamping of a work-piece.

25. The clamping device according to claim 24, wherein the clamping element is designed as several collets comprising segments which are connected to one another.

26. The clamping device according to claim 25, wherein the collet is essentially cylinder-shaped, and the segments are separated from one another by way of notches in an upper region of the cylinder, and a lower base region of the collet has a variable thickness, said thickness reducing towards the edge regions of the collet.

27. The clamping device according to claim 25, wherein an axial clamping path which is carried out by a collet or a clamping screw, lies in a range of 0.1-2 mm

28. The clamping device according to claim 25, wherein the collet for an outer clamping, in an upper region of the collet comprises a recess corresponding to the shape of a work-piece to be clamped.

29. The clamping device according to claim 25, wherein a conically shaped peg is arranged in the centre of the segments, for an inner clamping.

30. A clamping device with the base module according to claim 15 with a clamping element designed as a centering clamp.

31. A clamping device with the base module according to claim 18 with a clamping element for the inner clamping or outer clamping of a work-piece.

32. A clamping device with the base module according to claim 22 with a clamping element for the inner clamping or outer clamping of a work-piece.

33. A clamping device with the base module according to claim 23 with a clamping element for the inner clamping or outer clamping of a work-piece.
